(19) United States
(12) Patent Application Publication
(10) Pub. No.: US 2008/0061524 A1
(43) Pub. Date: Mar. 13, 2008

(54) Beach and Accessory Cart and Frame

(76) Inventor: Jacob Goldszer, Weston, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/530,528

(22) Filed: Sep. 11, 2006

(51) Int. Cl. B62B 3/00

(52) U.S. Cl. 280/47.34

(57) ABSTRACT

The collapsible cart includes forward leg members, rearward leg members, a lower frame, a forward frame gusset and a handle frame. The forward leg members are rotatably coupled to the rearward leg members. One end of the forward frame gusset is rotatably coupled to the forward leg members. The handle frame is pivotally mounted with respect to the forward leg members. The cart includes a lower frame with forward and rearward end portions, one of which is slidably mounted on the lower rear leg ends and other is pivotally hinged to the lower forward leg ends. In one embodiment, a slide lock structurally fixes the forward leg members to the handle frame. When unlocked, the handle frame pivots with respect to the forward leg members. A sack, bag or open ended flexible container is hung between the forward frame gusset and the handle frame.

The present invention relates to a beach or accessory cart which is a collapsible cart adapted to carry beach or other accessory items such as beach chairs, coolers, towels, blankets and food stuffs. A cart frame is also described.

### BACKGROUND OF THE INVENTION

Certain types of beach carts are known which are collapsible into a compact shape such that the cart can be stowed in the trunk of an automobile and carried reasonable distances and, with some ease, opened up such that the beach cart can carry beach towels, chairs, a cooler, blankets and other items commonly used by persons at the beach. Alternatively, the collapsible cart can be used to carry groceries and other items rather than simply beach accessories. The claims appended hereto are meant to cover these different aspects of the present invention.

Examples of collapsible carts include: U.S. Pat. Nos. 5,915,722; 5,988,671; 3,191,958; 3,627,342; 3,677,571; 3,693,993; 4,055,357; 4,222,585; 4,266,807; 4,429,897; 4,703,944; 4,790,559; 4,865,346; 4,887,837; and 5,197,754. U.S. Pat. No. 5,915,722 to Thrasher and U.S. Pat. No. 5,988,671 to Abelback disclose a collapsible beach cart but the lower frame of these beach carts are hinged to the forward legs and the rear legs.

### OBJECTS OF THE INVENTION

It is an object of the present invention to provide a collapsible cart which can easily be folded down into a compact structure and stowed in a trunk of a car and, in another mode, unfolded such that the bag or sack retained by the collapsible cart frame, can hold each accessories and other sundries.

It is another object of the present invention to provide a collapsible cart frame which is adapted to hold a bag, sack or other flexible container.

It is a further object of the present invention to provide a collapsible cart wherein the lower frame members slide up and down either the lower rear leg ends of the cart frame or the lower fore leg ends of the cart frame.

### SUMMARY OF THE INVENTION

The collapsible cart, sometimes utilized to carry beach accessories, includes forward leg members, rearward leg members, a lower frame, a forward frame gusset and a handle frame. The forward leg members are rotatably coupled to the rearward leg members. One end of the forward frame gusset is rotatably coupled to and rotates with respect to the forward leg members. The handle frame, at one end, is pivotally or rotationally mounted with respect to the forward leg members. The cart includes a lower frame with forward and rearward end portions, one of which is slidably mounted on the lower rear leg ends and other is pivotally hinged to the lower forward leg ends. In one embodiment, a slide lock structurally fixes the forward leg members to the handle frame and, in an unlocked mode, the lock permits the handle frame to pivot with respect to the forward leg members. A sack, bag or open ended flexible container is hung between the forward frame gusset and the handle frame. A set of wheels is mounted on the legs (two or four wheels). Alternatively, the lower frame can be slidably mounted on the lower fore leg ends and pivotally mounted to the lower rear leg ends.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates the frame for the collapsible cart in accordance with the principles of the present invention;

FIG. 2 diagrammatically illustrates one type of lock means, a slide lock, in accordance with the principles of the present invention (other lock means are described later);

FIGS. 3A and 3B diagrammatically illustrate the slide mount for the lower frame on the rear leg ends and the collapsing characteristic of the rear legs and the fore legs;

FIG. 4 diagrammatically illustrates a detailed view of the slide mount between the lower frame and one of the rear leg members;

FIG. 5 diagrammatically illustrates a top plan view of the lower frame;

FIG. 6 diagrammatically illustrates the collapsible cart with a mesh bag (other types of bags or sacks or flexible, open top containers may be hung on the cart) and a flexible back panel and a flexible bottom panel;

FIGS. 8A and 8B diagrammatically illustrate a different configuration of the slidable lower frame;

FIG. 9 diagrammatically illustrates the slide mount for the lower frame on the fore leg member;

FIG. 10 diagrammatically illustrates different locations for the pivotal hinge between various leg members and various frame members; and

FIG. 11 diagrammatically illustrates another pivotal frame mount system for the collapsible cart.

### DETAILED DESCRIPTION OF THE PREFERRED EMBODIMENTS

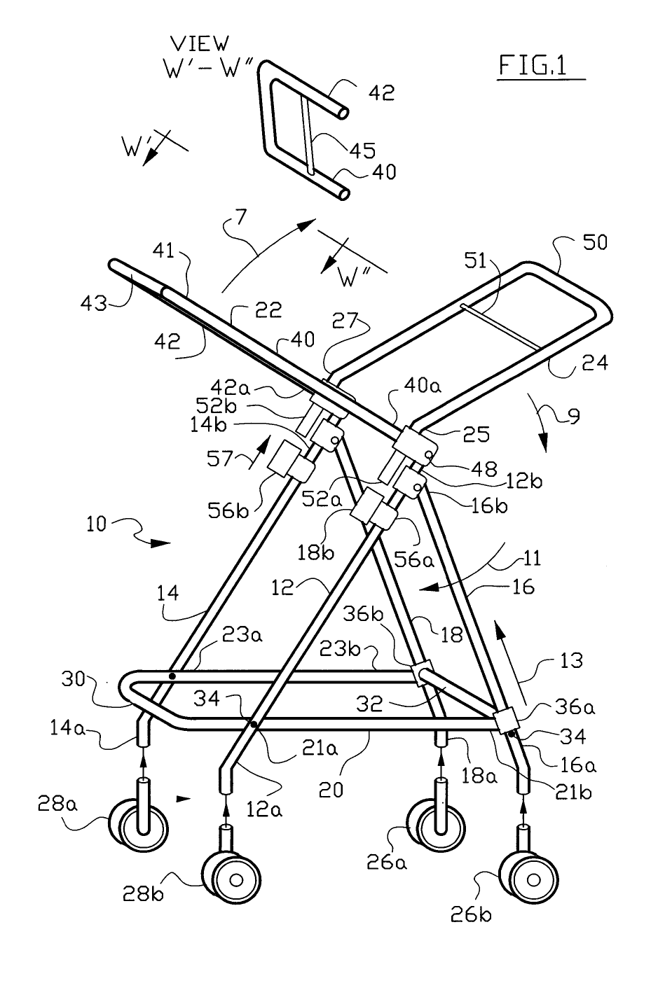

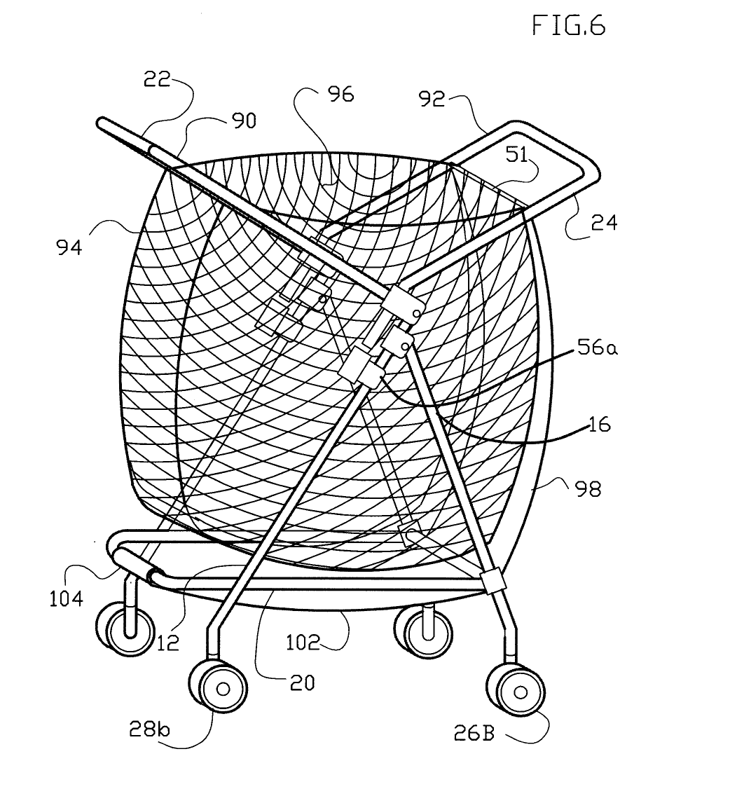

The present invention relates to a collapsible cart which can carry sundries and beach accessory items and a frame for such a cart. Similar numerals designate similar items throughout the drawings. Duplicate structures are found on similar frame members. The collapsible cart frame 10 is shown in FIG. 1. FIG. 6 shows the cart with a mesh sack and flexible support panels. The major structural items of cart frame 10 include a pair of forward leg members 12, 14, a pair of rearward leg members 16, 18, a lower frame 20, a forward frame gusset 22, and a handle frame member 24. In summary, frame gusset 22 is pivotally mounted with respect to forward leg members 12, 14. Various rotational mount systems maybe used. Handle frame member 24 is also pivotally mounted with respect to forward frame members 12, 14. Rearward leg members 16, 18 are also pivotally mounted with respect to forward leg frame members 12, 14. The pivotal mounting of these various frame members 22, 24, 16, 18 enable the collapsible cart frame to be re-configured from the fully expanded shape of FIG. 1 and collapsed into a compact shape by moving frame members in the direction shown by arrows 7, 9 and 11.

In addition, collapsible cart frame 10 includes a lower frame 20 which has one of its ends slidably mounted on either the rear leg members or the fore end leg members and the other of its ends pivotally mounted on the other of the forward or rear end legs. In the embodiment shown in FIG. 1, the forward end portions of lower frame 20 are pivotally mounted on forward leg members 12, 14 and the rearward end portions of lower frame 20 are slidably mounted on the rear legs such that lower frame 20 can be slid upward in the direction shown by arrow 14 thereby completely collapsing the rearward legs in addition to collapsing the handle frame member and the forward frame gusset generally proximal and adjacent forward leg members 12, 14. The frame essentially collapses on the forward leg members. Wheel sets 26a and 26b are mounted to the lowest leg portions of the rearward legs such that the collapsible cart frame 10 can be moved across the ground, clay or sand. Another wheel set 28a, 28b can be mounted on the forward leg members 12, 24 such that a four wheel set can be utilized rather than a two wheel set. The wheels may be much larger than shown herein.

Forward leg members 12, 14 each include lower fore leg ends 12a, 14a and upper fore leg ends 12b, 14b. Rearward leg members 16, 18 each include lower rear leg ends 16a, 18a, and upper rear leg ends 16b and 18b. Lower frame 20 includes forward end portions 21a, 23a and rearward end portions 21b, 23b. In addition, lower frame 20 includes forward cross piece 30 and a rearward cross piece 32 both shown in FIG. 5. Lower frame 20 is pivotally hinged or rotatably attached to lower fore leg ends 12a, 14a, at respective pivot point, one of which is pivot point 34. Rear end portions 21b, 23b are mounted to sleeves 36a, 36b which sleeves slide up and down rear leg members 16, 18 as shown by arrow 13. A stop pin 34 limits lower movement of lower frame 20 on rear leg members 16, 18. Leg 18 may also include a duplicate stop.

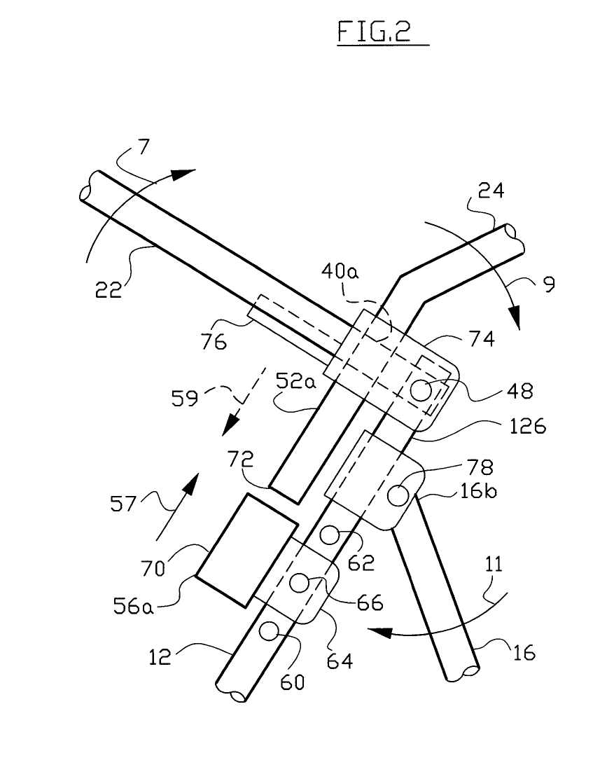

Forward frame gusset 22 is generally an inverted U-shaped member having legs 40, 42. Gusset frame legs 40, 42, are joined by a free end portion in region 41 and each leg has coupling end portions 40a, 42a. For stability, free end portion 41 of frame gusset 22 includes a cross piece 43. A further cross piece 45 is provided for hanging a bag or sack. Cross piece 45 as well as the cross piece 51 on handle frame member 24 may be eliminated and a bead or reinforced bag seam used thereat. Coupling end portions 40a, 42a are pivotally mounted with respect to the forward leg members 12, 14, in this embodiment, by a rotatable pivot mount one of which is shown as mount 48. Forward gusset 22 cooperates with a stop (shown in FIG. 2) which limits its rotational movement in the direction contrary to directional arrow 7.

Handle frame member 24 is, in this embodiment, a generally inverted U-shaped frame member having a handle portion 50 and having forward coupling end portions 52a, 52b. Coupling end portions 52a, 52b, cooperate with a locking means, shown herein as slide lock with movable members 56a, 56b. These movable lock members 56a, 56b move in the direction shown by arrows 57. When the locking means are disengaged and in the position contrary to the direction of arrow 57, handle frame member 24 can be rotatably moved away from leg ends 12b, 14b in the direction shown by arrow 9 as well as arrow 11 towards the main body of forward leg members 12, 14. Handle frame member 24 also includes a cross piece 51 which assists in the hanging of the sack or bag as well as the flexible back panel discussed later in connection with FIG. 6.

FIG. 2 diagrammatically illustrates a detail of the locking means. In the preferred embodiment, locking means is a slide lock 56a which slides forward and back as shown by arrows 57, 59 on the upper forward leg end 12b. A similar lock is provided on upper fore leg end 14b as shown in FIG. 1. FIG. 1 shows the lock OPEN and FIG. 6 shows it CLOSED. Other locking means are discussed later. Downward movement of slide lock 56a is prohibited by stop 60. In one embodiment, slide lock 56a is moved forward by depressing spring loaded extensible pin 62 such that the sleeve 64 passes over the pin. When slide lock 56a is in the fully locked position, the spring loaded pin 62 extends through hole or aperture 66 of sleeve 64. To release the lock to the unlocked mode, pin 62 is depressed and slide lock 56a is moved in the direction shown by arrow 59 until the slide lock 56a and particularly sleeve 64 has moved downward beyond spring loaded pin 62. The slide lock operates to provide a structural fixation between forward leg members 12, 14 and the forward coupling ends 52a, 52b of handle frame member 24. In one embodiment, the slide lock includes a locking sleeve 70 that has an open ended channel within which is inserted the end portion 72 of the forward coupling end portion 52a of handle frame 24.

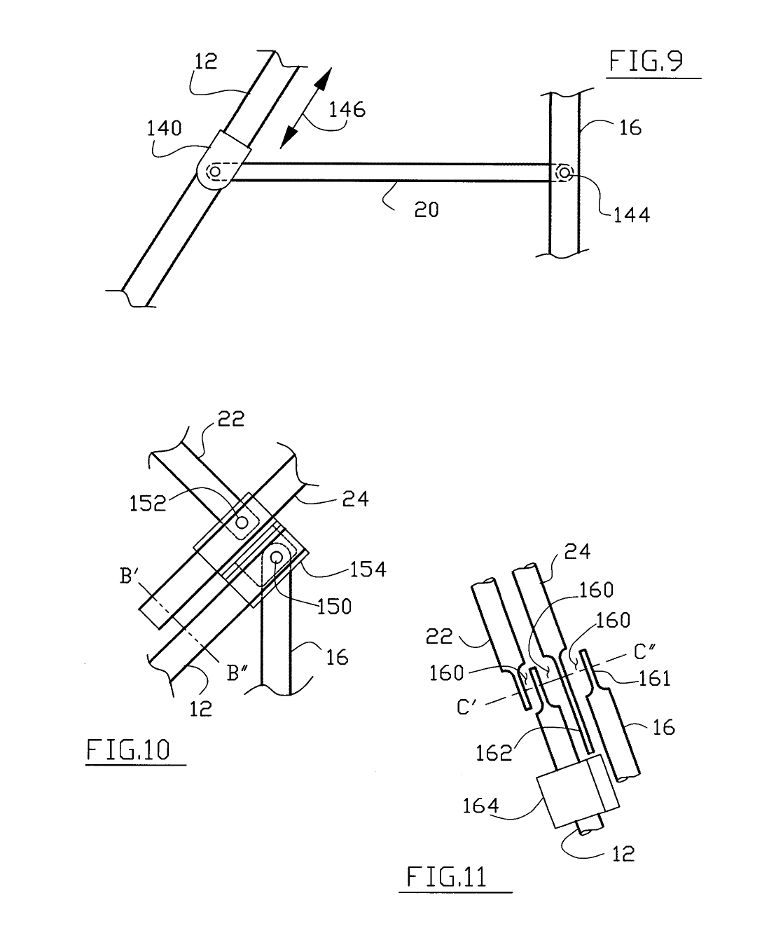

FIG. 2 also shows that pivot point 48 provides a pivot between the forward leg member 12 and the forward frame gusset 22. Bracket 74 is affixed to handle 24 and retains pivot pin 48 and rotatably supports frame gusset 22 and handle frame 24 with respect to forward legs 12, 14. Of course, there are many other mechanisms to provide such pivoting action. One important aspect herein is that the frame gusset, the handle frame and the rear legs are all pivotally mounted with respect to the forward frame legs. Other pivot systems are shown and discussed later in connection with FIGS. 10 and 11.

To limit the counterclockwise movement (contrary to directional arrow 7) of forward frame gusset 22, bracket 74 includes a stop 76. In the fully expanded mode, frame gusset 22 rests against the stop 76. In a collapsing mode, the frame gusset is swung in direction of arrow 7 such that the frame gusset is adjacent the handle frame member 24. FIG. 2 also shows that rear leg 16 is pivotally mounted at point 78 to forward leg 12.

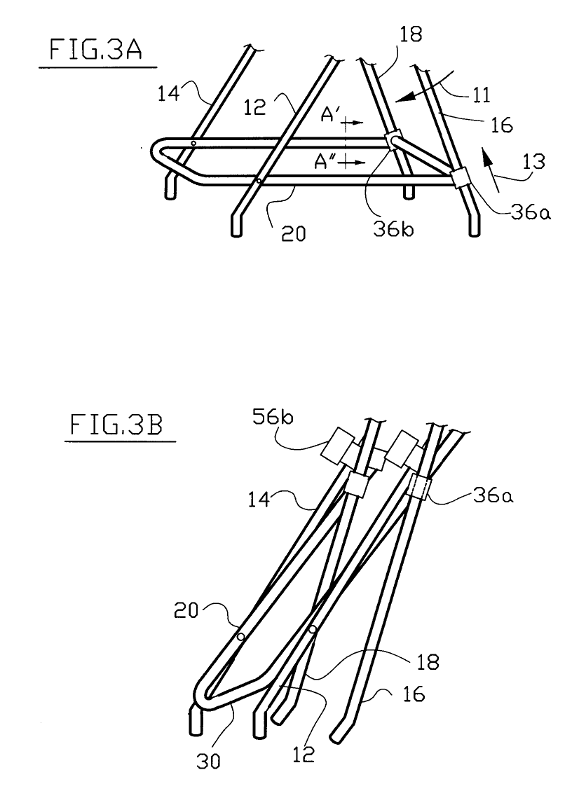

FIGS. 3A and 3B diagrammatically illustrate the slidable mount of the lower frame and collapsing of rear leg members 16, 18 with respect to forward leg members 12, 14. The slide mounts 36a, 36b are moved in the direction of arrow 13 up rear legs 16, 18, the lower frame pivots at its fore end, and the lower frame 20 causes legs 16, 18 to move and collapse toward forward legs 12, 14.

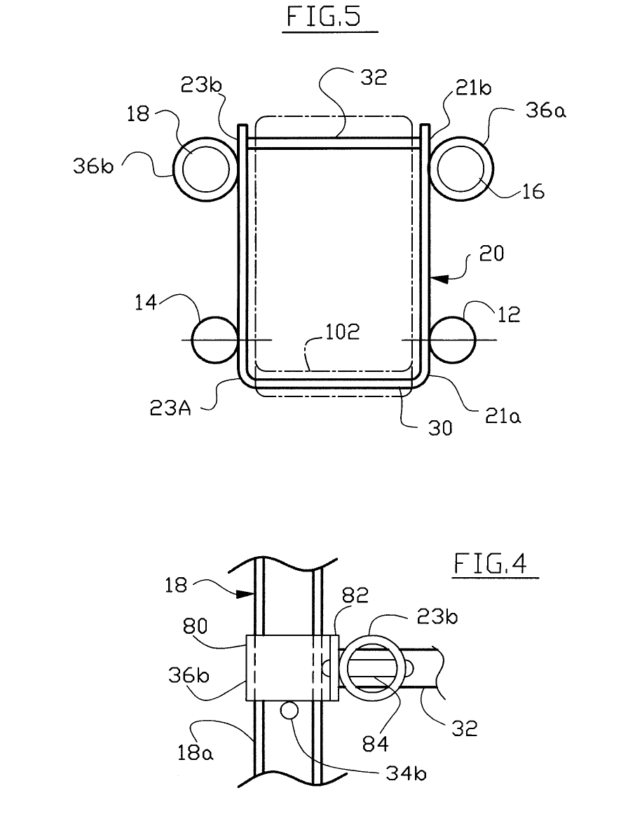

FIG. 4 is a detailed view of the slide mount 36b from the perspective of section line A′A″ in FIG. 3A. The slide mount 36b includes a sleeve 80 that moves up and down (but not past stop 34b) lower leg end 18a of rear leg 18. Attached to sleeve 80 is, in this embodiment, a small plate 82. Rearward end portion 23b of frame 20 is generally pivotally attached by pin 84 to the small plate 82 extending normal to leg 18 and member 32. The rear lower frame strut 32 is shown in FIG. 4.

FIG. 5 diagrammatically shows a plan view of lower frame 20. In the illustrated embodiment, lower frame 20 is pivotally attached to forward legs 12, 14 as diagrammatically shown at forward end portions 21a, 23a. The lower frame includes forward frame strut or member 30 and rearward frame member 32 at rearward end portions 21b, 23b. The slide mounts 36a, 36b are shown about rear legs 16, 18. The dashed lines in FIG. 5 generally show the plan view for the flexible lower panel discussed above in FIG. 6. The flexible lower panel (cloth or nylon) wraps around strut 30.

FIG. 6 diagrammatically shows a sack hung on the mid-section 90 of forward frame gusset 22 and the mid-section 92 of the handle frame member 24. In the illustrated embodiment, sack 94 is a mesh sack or bag or open ended flexible container. Sack 94 has an open top 96 and this open top is held open by either hook and loop attachment to the mid-sections of each U-shaped portion of frame gusset 22 and U-shaped frame leg members of handle 24 or by wrap around mount to cross pieces 45, 24. See FIG. 1. Hook and loop, snaps, tie-offs or belt and belt buckles may removably attach the sack to the cart frame. An open mesh bag is preferable because the bag does not collect sand and other debris commonly found on beaches.

In addition, a flexible back panel 98 is hung from the mid-section of handle frame member 24 to at least the lower end of the rear leg members 16, 18. In a preferred embodiment, the flexible back panel 98 is nylon or other type of easily cleaned cloth. Further, in a preferred embodiment, the flexible back panel 98 includes a lower panel 102 which is contiguous with the back panel 98 and further the lower flexible panel wraps around 102 at forward edge 104 the forward strut 30 of lower frame 20. See FIGS. 1 and 5. In FIG. 5, the lower flexible panel is shown in dashed lines. The back panel 98 can loosely pass over attached to the rear strut of lower frame 20 (see rear strut 32 of frame 20 in FIG. 5).

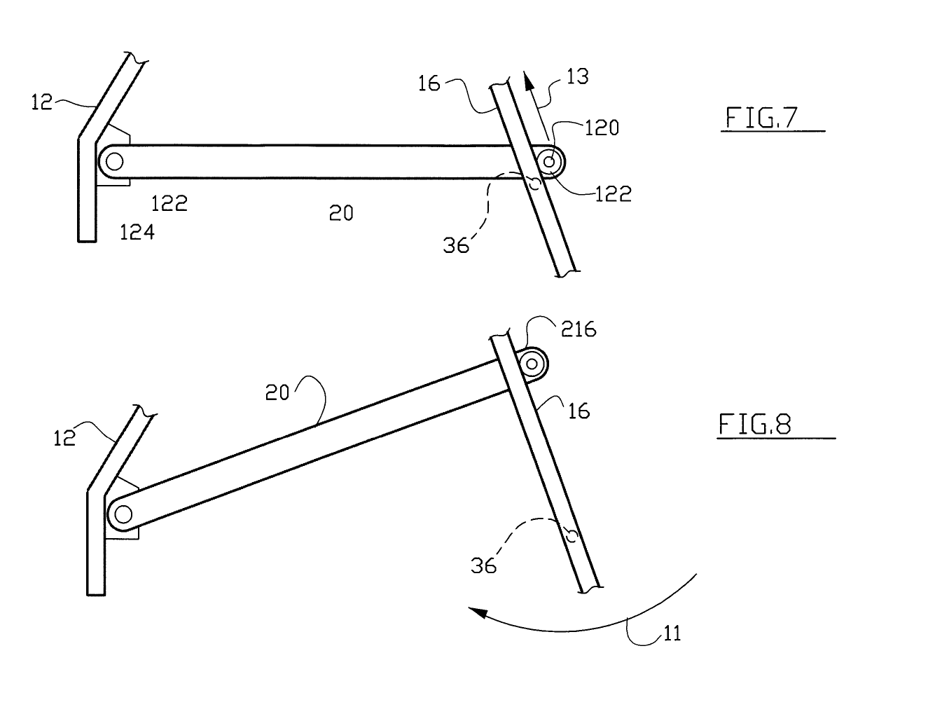

FIGS. 8A and 8B diagrammatically show another embodiment wherein lower frame 20 is slidably mounted on the rear legs 16, 18 with a pin 120 and a low friction cylindrical roller 122 on the frame ends. The cylindrical roller moves or slides up and down on leg 16, 18 as shown by arrow 13 traveling along the rear side of rear leg 16. The forward end of lower frame 20 is hinged at point 122 via bracket 124 to the lower end of forward leg member 12. FIG. 8B shows that lower leg 20 and particularly rear end portion 21b has moved upward on leg 16 thereby moving leg 16 in the direction of arrow 11 towards forward leg 12.

The lower frame may be slidably mounted to the rear legs via a pin movably disposed in a longitudinal channel formed in rear legs 16, 18. The pin has a head captured by the under-side of the channel such that the pin element does not move out of the chanel.

FIG. 9 shows a potential variation on the system wherein slide member 140 is movably mounted on forward leg 12 and the rear portion of lower frame 20 is hinged at point 144 to the rear leg 16. In this situation, the slide 140 moves in the appropriate direction 146 along forward leg 12 to collapse the entire cart.

FIG. 10 shows a bracket 154 that has pivot points 150 for forward leg 12 and rear leg 16 and pivot point 152 for handle frame 24 and forward frame gusset 22. Other types of locking mechanisms could be placed on section line B′B″ such as a belt or strap, a velcro wrap-around tie down, a nut and bolt system, that would run along the axis of line B′-B″, a plate which is hinged to one or the other of the handle or the front leg. The plate has a cutout and the other frame member, either handle 24 or leg 12, has an extending pin that interfaces and locks within the plate channel and the plate and pin thereby structurally fixing the handle a fixed distance away from forward leg 12. A loop with snap attachment operative on two pins extending laterally from handle 24 and leg 12 may also be employed. The loop ends have a snap or loop which snap or loop attaches over either extending pin thereby prohibiting rotational movement of the handle 24 with respect to the forward leg 12.

FIG. 11 diagrammatically shows a different hinged attachment. Forward leg 12 is hingeably mounted to rear leg 16 and handle 24 is also pivotally mounted to the same pivot point along axis C′-C″ as is frame gusset 22. Spacers 160 may be placed in the inter-space between thin plate end pieces, one of which is end piece 161 of rear leg 16. A modified slide lock 164 would extend into extending thin plate end piece 162 extending from the tubular end of handle 24.

The claims appended hereto are meant to cover modifications and changes within the scope and spirit of the present invention.

What is claimed is:

1. A collapsible cart adapted to carry beach accessory items comprising:
a forward pair of leg members each with a lower fore leg end and an upper fore leg end;
a rearward pair of leg members each with a lower rear leg end and an upper rear leg end;
said upper fore leg ends of each forward leg members coupled, via respective pivot elements, to corresponding upper rear leg ends of said rear leg members;
a lower frame having forward end portions and rearward end portions, said forward end portions pivotally hinged to respective ones of said lower fore leg ends and said rearward end portions of said lower frame slidably movably mounted on respective ones of said lower rear leg ends;
a forward frame gusset having a free end portion and a pair of rearward, coupling end portions, respective rearward coupling end portions pivotally mounted with respect to said forward pair of leg members;
a handle frame member having a rearward handle portion and a pair of forward coupling end portions and a corresponding pair of locking surfaces, respective forward coupling end portions pivotally mounted with respect to said forward pair of leg members;
a locking means operable between said forward pair of leg members and said forward coupling end portions of said handle frame and having a locked mode and an unlocked mode, in said locked mode, said locking means structurally fixing said forward pair of leg members to said forward coupling end portions of said handle frame and, in said unlocked mode, said locking means permitting said handle to pivot with respect to said forward pair of leg members;
a sack having an open end, said sack hung between said free end portion of said forward frame gusset and rearward handle portion of said handle frame member; and
a set of wheels on either said lower rear leg ends or on said lower rear leg ends and said lower fore leg ends.

2. A collapsible cart as claimed in claim 1 including a back panel of flexible material hung between rearward handle portion and said rearward end portions of said lower frame.

3. A collapsible cart as claimed in claim 2 wherein said back panel includes a lower, forward section which lower forward panel section is hung between said forward end portions of said lower frame and said rearward end portions of said lower frame.

4. A collapsible cart as claimed in claim 3 wherein said back panel and said lower, forward section is a substantially continuous piece of flexible material.

5. A collapsible cart as claimed in claim 1 wherein said sack is a mesh bag.

6. A collapsible cart as claimed in claim 4 wherein said sack is a mesh bag.

7. A collapsible cart as claimed in claim 1 wherein said locking means includes a pair of slide locks each slide lock slidably movably mounted on a respective one of said upper fore leg ends.

8. A collapsible cart as claimed in claim 7 wherein said slide locks include a capture channel which embraces said forward coupling end portions of said handle frame.

9. A collapsible cart as claimed in claim 1 including a stop for said forward frame gusset on one of said forward coupling end portions of said handle frame, said upper rear leg ends of said rearward leg members, and said upper fore leg ends of said forward leg members, said stop limiting pivotally movement of said forward frame gusset to one direction with respect to said forward pair of leg members.

10. A collapsible cart as claimed in claim 1 wherein said rearward, coupling end portions of said forward frame gusset are pivotally mounted to either said forward coupling end portions of said handle frame member or said upper rear leg ends of said rearward leg members, or said upper fore leg ends of said forward leg members.

11. A collapsible cart as claimed in claim 1 wherein forward coupling end portions of said handle frame member are pivotally mounted to either rearward, coupling end portions of said forward frame gusset or said upper rear leg ends of said rearward leg members, or said upper fore leg ends of said forward leg members.

12. A collapsible cart as claimed in claim 1 wherein handle frame member has a mid-section and said forward frame gusset has a mid-section and said sack is hung from said handle frame mid-section and is hung from said forward frame gusset mid-section.

13. A collapsible cart as claimed in claim 1 wherein said rearward end portions of said lower frame each include a sleeve within which slides said lower rear leg ends.

14. A collapsible cart as claimed in claim 1 wherein said rearward end portions of said lower frame each include a slide bar which travels over said lower rear leg ends.

15. A collapsible cart as claimed in claim 1 wherein said lower frame has four frame sides.

16. A collapsible cart adapted to carry beach accessory items comprising:
a forward pair of leg members each with a lower fore leg end and an upper fore leg end;
a rearward pair of leg members each with a lower rear leg end and an upper rear leg end;
said upper fore leg ends of each forward leg members coupled, via respective pivot elements, to corresponding upper rear leg ends of said rear leg members;
a lower frame having forward end portions and rearward end portions, said rearward end portions pivotally hinged to respective ones of said lower rear leg ends and said forward end portions of said lower frame slidably movably mounted on respective ones of said lower fore leg ends;
a forward frame gusset having a free end portion and a pair of rearward, coupling end portions, respective rearward coupling end portions pivotally mounted with respect to said forward pair of leg members;
a handle frame member having a rearward handle portion and a pair of forward coupling end portions and a corresponding pair of locking surfaces, respective forward coupling end portions pivotally mounted with respect to said forward pair of leg members;
a locking means operable between said forward pair of leg members and said forward coupling end portions of said handle frame and having a locked mode and an unlocked mode, in said locked mode, said locking means structurally fixing said forward pair of leg members to said forward coupling end portions of said handle frame and, in said unlocked mode, said locking means permitting said handle to pivot with respect to said forward pair of leg members;
a sack having an open end, said sack hung between said free end portion of said forward frame gusset and rearward handle portion of said handle frame member; and
a set of wheels on either said lower rear leg ends or on said lower rear leg ends and said lower fore leg ends.

17. A collapsible cart as claimed in claim 16 including a back panel of flexible material hung between rearward handle portion and said rearward end portions of said lower frame and a lower, forward flexible panel section hung between said forward end portions of said lower frame and said rearward end portions of said lower frame and wherein said sack is a mesh bag.

18. A collapsible cart frame adapted to hold open an open end of a sack and retain the sack above a ground plane to carry beach accessory items comprising:
a forward pair of leg members each with a lower fore leg end and an upper fore leg end;
a rearward pair of leg members each with a lower rear leg end and an upper rear leg end;
said upper fore leg ends of each forward leg members coupled, via respective pivot elements, to corresponding upper rear leg ends of said rear leg members;
a lower frame having forward end portions and rearward end portions, said forward end portions pivotally hinged to respective ones of said lower fore leg ends and said rearward end portions of said lower frame slidably movably mounted on respective ones of said lower rear leg ends;
a forward frame gusset having a free end portion and a pair of rearward, coupling end portions, respective rearward coupling end portions pivotally mounted with respect to said forward pair of leg members;
a handle frame member having a rearward handle portion and a pair of forward coupling end portions and a corresponding pair of locking surfaces, respective forward coupling end portions pivotally mounted with respect to said forward pair of leg members;
a locking means operable between said forward pair of leg members and said forward coupling end portions of said handle frame and having a locked mode and an unlocked mode, in said locked mode, said locking means structurally fixing said forward pair of leg members to said forward coupling end portions of said handle frame and, in said unlocked mode, said locking means permitting said handle to pivot with respect to said forward pair of leg members;
a set of wheels on either said lower rear leg ends or on said lower rear leg ends and said lower fore leg ends;
wherein said open end of said sack is adapted to be hung between said free end portion of said forward frame gusset and rearward handle portion of said handle frame member.
